(19) United States
(12) Patent Application Publication
(10) Pub. No.: US 2010/0194187 A1
(43) Pub. Date: Aug. 5, 2010

(54) Bicycle safety apparatus

(76) Inventor: Lindsay Howard, Kirkland, WA (US)

Correspondence Address: CHARLES J RUPNICK, PO BOX 46752, SEATTLE, WA, 98146, US

(21) Appl. No.: 12/322,778

(22) Filed: Feb. 5, 2009

(51) Int. Cl. B60T 8/38; G08C 19/00

(52) U.S. Cl. 303/162; 340/825.69

(57) ABSTRACT

A safety apparatus for a rider motivated wheeled vehicle, the safety apparatus including a remote control module and a remotely actuable braking apparatus. The remote control module includes an electronic control signal activation module, a manual signal activator coupled for activating the electronic control signal activation module for generating a control signal, and a power supply coupled for powering the electronic control signal activation module. The remotely actuable braking apparatus includes an auxiliary brake device that is positionable for engaging at least one wheel of a rider motivated wheeled vehicle; an electronic actuator module coupled to the auxiliary brake device and being responsive to a received control signal for operating the auxiliary brake device, and a power supply coupled for powering the actuator module.

### FIELD OF THE INVENTION

The present invention relates generally to bicycle braking devices, and in particular to remotely actuated braking devices for a bicycle and radio apparatus for remotely controlling such bicycle braking devices.

### BACKGROUND OF THE INVENTION

Remotely actuated braking devices are generally well-known for the operator of a towing vehicle to remotely control another vehicle being towed by the towing vehicle. It is also known utilize a wireless transmitter and receiver to achieve remote actuation of a towed vehicle's brake system to provide such remote control.

However, all such remote brake activations systems require the remotely activated brake system to actuate the towed vehicle's original brake system in the manner normally used by the vehicle operator for self-stopping of the vehicle. Thus, the remotely activated brake actuator is coupled into the vehicle brake system at the foot pedal or equivalent point as is normally used by the towed vehicle operator to apply the vehicle's brakes for self-stopping of the vehicle. In other words, the known remote brake activations systems requires a push rod or a pull cable that mechanically interconnects the brake actuator to the brake pedal of the towed vehicle. Furthermore, such remote brake activations systems create a master-slave relationship between the brakes of the towing vehicle and those of the towed vehicle, such that actuation of the brake pedal on the towed vehicle is a response to activation of the brake pedal on the towing vehicle. Often, the towing vehicle even provides the motive power for driving the brake actuator on the towed vehicle since the towed vehicle may be incapable of providing such motive power, for example in the case of the towed vehicle having power brakes that require the towed vehicle's motor to operate normally.

Remote brake activations systems are also known for non-towed vehicles, such as locomotives, and remote-controlled toy cars. However, all such remote brake activations systems discovered operate the vehicle's original brake system in the manner normally used by the vehicle operator for stopping of the vehicle.

### SUMMARY OF THE INVENTION

Through personal experience the inventor has determined that, even under the careful supervision of a responsible observer, bicycles and other vehicles under the motive power and direct control of inexperienced or unobservant operators, especially young children, are sometimes operated unsafely. Such unsafe operation may put the child operator at risk of guiding the bicycle or other vehicle into busy streets or other potentially hazardous areas. The inventor has also determined that to date technology has not provided an effective apparatus or method for restraining the child operator.

Accordingly, the present invention overcomes the limitations of the prior art for restraining a child or other inexperienced or unobservant operator at risk of entering a potentially hazardous area by providing a safety apparatus for a rider motivated wheeled vehicle including any wheeled vehicle normally propelled by motive force of the rider applied to one or more pedals coupled to the wheel or wheels, including but not limited to a bicycle, a unicycle, a tricycle, a toy cars or wagon, or another wheeled vehicle propelled by motive force of the rider, including but not limited to a wheel chair.

According to one aspect, the safety apparatus for a rider motivated wheeled vehicle includes two basic components: a remote control module and a remotely actuable braking apparatus. According to one embodiment, the remote control module includes: an electronic control signal activation module having a control signal generator and a control signal transmitter, a power supply that is coupled for powering the electronic control signal activation module, and a manual switch that is coupled for coupling the power supply to the electronic control signal activation module for generating and wirelessly transmitting the control signal.

The remotely actuable braking apparatus includes: an auxiliary brake device that is attachable to a frame of a bicycle in operable proximity to a wheel thereof, and an actuator module that is coupled for operating the auxiliary brake device, the actuator module having an actuator drive module that is responsive to the wirelessly transmitted control signal for generating an actuator drive signal, an actuator that is coupled to the actuator drive module for receiving the actuator drive signal generated thereby and is further coupled for operating the auxiliary brake device responsively to receiving the received actuator drive signal, and a power supply that is coupled for powering the actuator drive module and actuator.

According to another aspect of the safety apparatus, the electronic control signal activation module further includes a signal amplifier that is coupled for amplifying the generated control signal, and an antenna that is coupled for transmitting the amplified control signal.

According to another aspect of the safety apparatus, the actuator drive module further includes: an antenna, a receiver that is coupled to the antenna for receiving the control signal, and an actuator drive signal generator that is coupled to the receiver for responsively generating the actuator drive signal.

According to another aspect of the safety apparatus, the actuator further includes a linear actuator having a piston rod that is coupled to operate the auxiliary brake device for engaging the bicycle wheel in operable proximity thereto.

According to another aspect of the safety apparatus, the remotely actuable braking apparatus further includes an actuator cable that is coupled between the linear actuator and an operative portion of the auxiliary brake device.

According to another aspect of the invention, a safety method is provided for using the safety apparatus for protecting the rider of a wheeled vehicle normally propelled by motive force of the rider. According to one aspect of the safety method for a rider motivated wheeled vehicle, the safety method includes: mounting a remotely actuable braking apparatus on the wheeled vehicle by attaching a brake device to a frame of a bicycle in operable proximity to a wheel thereof, and attaching an actuator module to the bicycle frame in operable coupling with the brake device. An observer then observes the wheeled vehicle being operated by a rider. Upon observing the wheeled vehicle being operated in a manner or circumstance unsafe for a rider, the observer responsively operates a handheld electronic radio frequency remote control module for remotely controlling the remotely actuable braking apparatus, the observer operating the remote control module further including the operator actuating a radio frequency control signal for engaging the brake device with the wheel of the wheeled vehicle. The method further includes the actuator module of the remotely actuable braking apparatus receiving the radio frequency control signal and responsively engaging the brake device with the wheel of the wheeled vehicle.

According to another aspect of the safety method, the safety method further includes the observer again operating the handheld electronic radio frequency remote control module, which includes actuating a radio frequency control signal that disengages the brake device from engagement with the wheel of the wheeled vehicle.

According to another aspect of the safety method, the observer's actuating of the radio frequency control signal for engaging the brake device with the wheel of the wheeled vehicle further includes either: energizing an electronic control signal activation module for generating and transmitting the radio frequency control signal which signal is received and causes the brake device to responsively engage the wheel of the wheeled vehicle, or alternatively de-energizing the electronic control signal activation module for interrupting a substantially continuous generating and transmitting of the radio frequency control signal which, when the continuously received signal holds the brake device from engagement with the wheel, the interruption of the signal causes the brake device to responsively engage the wheel of the wheeled vehicle.

According to another aspect of the safety method, the observer's actuating a radio frequency control signal for engaging the brake device with the wheel of the wheeled vehicle further includes only energizing an electronic control signal activation module for generating and transmitting the radio frequency control signal. Here, the energizing an electronic control signal activation module for generating and transmitting the radio frequency control signal further includes: closing a switch for actively coupling a power supply to the electronic control signal activation module; and coupling the power supply to the electronic control signal activation module initiates operating of a radio frequency control signal generator for generating the radio frequency control signal, amplifying the generated radio frequency control signal, and transmitting the amplified radio frequency control signal to the actuator module on the wheeled vehicle.

According to another aspect of the safety method, the actuator module of the remotely actuable braking apparatus receiving the radio frequency control signal and responsively engaging the brake device with the wheel of the wheeled vehicle further includes: receiving the radio frequency control signal by means of a radio frequency signal reception antenna; tuning a radio frequency signal receiver appropriately for receiving the radio frequency control signal; the tuned radio frequency signal receiver receiving the radio frequency control signal; the tuned radio frequency signal receiver then passing the received radio frequency control signal to an actuator drive signal generator that is coupled to the radio frequency signal receiver; the actuator drive signal generator then generating an actuator drive signal in response to receiving the radio frequency control signal; the actuator drive signal generator then passing the actuator drive signal to an actuator that is coupled to the actuator drive signal generator for receiving the actuator drive signal generated thereby; and responsively to receiving the actuator drive signal, the actuator then operating the brake device for engaging the brake device with the wheel of the wheeled vehicle.

According to another aspect of the safety method, the observer's actuating a radio frequency control signal for engaging the brake device with the wheel of the wheeled vehicle further includes initially operating the energizing the electronic control signal activation module for generating and transmitting the radio frequency control signal, which includes coupling a power supply to the electronic control signal activation module initiating the operating of a radio frequency control signal generator for substantially continuously generating the radio frequency control signal, then amplifying the generated radio frequency control signal, and transmitting the amplified radio frequency control signal. Furthermore, the actuator module of the remotely actuable braking apparatus receiving the radio frequency control signal further includes engaging the brake device with the wheel of the wheeled vehicle in response to receiving the radio frequency control signal. Additionally, the observer's actuating of the radio frequency control signal for engaging the brake device with the wheel of the wheeled vehicle further includes interrupting the substantially continuously generating and transmitting of the radio frequency control signal, which includes actuating a switch for decoupling a power supply from at least a transmitting portion of the electronic control signal activation module which operates to de-energize at least the transmitting portion of the electronic control signal activation module, and the de-energizing the transmitting portion of the electronic control signal activation module causes at least momentary ceasing of transmitting the radio frequency control signal.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a child's bicycle being controlled by the bicycle's rider, and also illustrates a novel child bicycle safety apparatus for emergency remote braking of the child's bicycle;

FIG. 2 illustrates one embodiment of a remotely actuable braking apparatus portion of the novel child bicycle safety apparatus;

FIG. 3 is a block diagram that illustrates by example and without limitation a radio remote control module portion of the novel child bicycle safety apparatus for remotely controlling bicycle braking apparatus;

FIG. 4 illustrates one embodiment of the novel bicycle safety apparatus being mounted as an auxiliary brake device on a bicycle equipped with a set of original equipment (OEM) caliper brakes;

FIG. 5 illustrates another embodiment of the novel bicycle safety apparatus being mounted on a bicycle equipped with the set of OEM caliper brakes wherein the novel bicycle safety apparatus incorporates the OEM caliper brakes; and

FIG. 6 illustrates a method of operation of the novel bicycle safety apparatus when a child rider is observed operating the bicycle unsafely such as guiding the bicycle down a hill toward a cross street or other potentially hazardous area, or otherwise being at risk of entering such potentially hazardous area.

### DETAILED DESCRIPTION OF PREFERRED EMBODIMENT

In the Figures, like numerals indicate like elements.

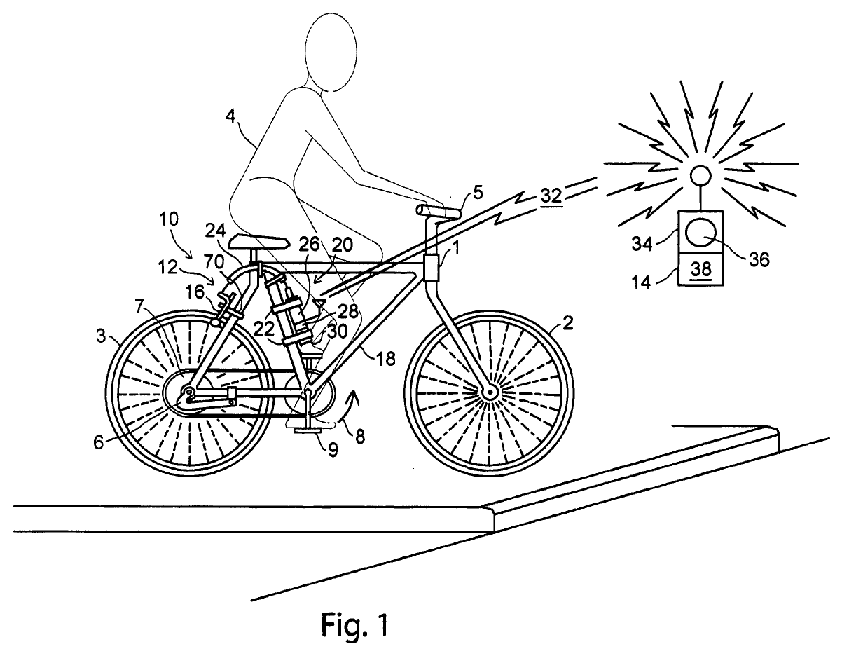

FIG. 1 illustrates a child's bicycle 1 having front and rear wheels 2, 3 with the front wheel 2 being controlled by the bicycle's rider 4 through a handlebar 5. The child's bicycle 1 as illustrated here is of a well-known type having a coaster or drag brake 6 mounted on a hub 7 of the rear wheel 3 and activated by the bicycle's rider 4 reverse pedaling (arrow 8) of the pedals 9.

FIG. 1 also illustrates a novel child bicycle safety apparatus 10 for emergency remote braking of child's bicycle 1. Child bicycle safety apparatus 10 is formed of a remotely actuable braking apparatus 12 and a handheld electronic radio frequency remote control module 14 for remotely controlling bicycle braking apparatus 12. The remotely actuable braking apparatus 12 includes an auxiliary brake device 16 mounted on the bicycle's frame 18 in a position to operate on the bicycle's rear wheel 3 for stopping the bicycle 1. By example and without limitation, the auxiliary brake device 16 is embodied as a conventional caliper brake. An actuator module 20 is mounted on the bicycle 1 in a position to actuate the auxiliary brake device 16. For example, one or more anchors 22 couple the actuator module 20 to the bicycle's frame 18 either adjacent to the auxiliary brake device 16 or in a more remote position. The actuator module 20 is coupled to the auxiliary brake device 16 for actuating the brake device 16. According to one embodiment of the child bicycle safety apparatus 10, the actuator module 20 is coupled by an actuator cable 24 to the auxiliary brake device 16 for actuating the brake device 16. The actuator module 20 includes a brake actuator 26 coupled to the actuator cable 24 opposite from the auxiliary brake device 16. An electronic actuator drive module 28 is coupled to drive the brake actuator 26 for actuating the auxiliary brake device 16. A battery pack or other power supply 30 is coupled to power the electronic actuator drive module 28 and brake actuator 26.

The electronic actuator drive module 28 is responsive to a radio frequency control signal (indicated at 32) received from the remote control module 14. The remote control module 14 includes an electronic control signal activation module 34 that is responsive to operation of a switch or other manual signal activator 36 for generating and transmitting the radio frequency control signal 32. A battery pack or other power supply 38 is coupled to power the electronic control signal activation module 34. According to one embodiment the electronic actuator drive module 28 is operable using a safe 12 volt DC (direct current) battery pack or other power supply 38.

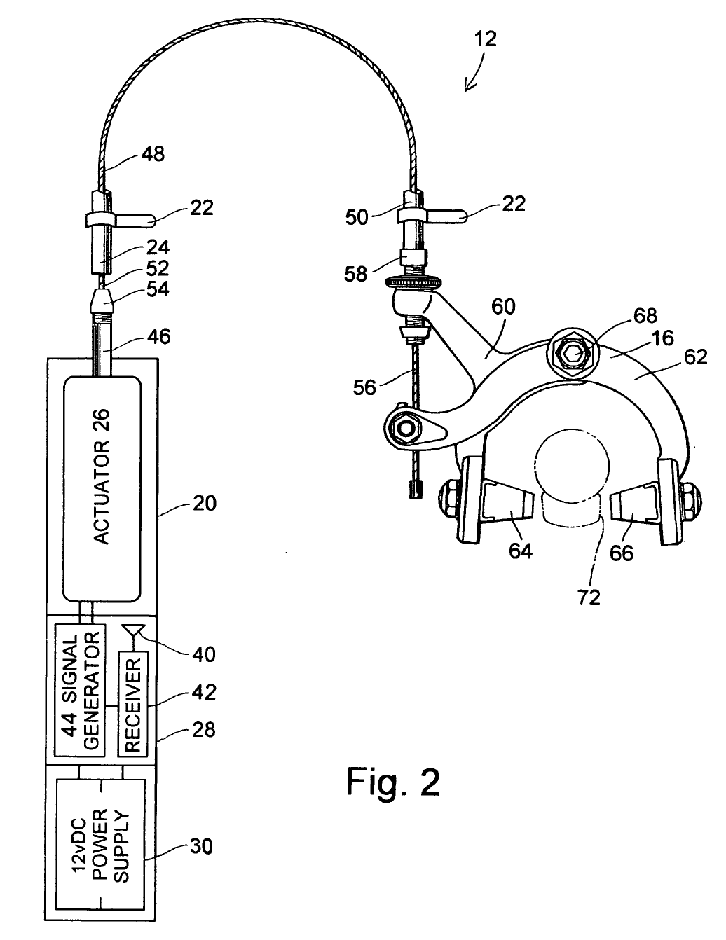

FIG. 2 illustrates one embodiment of the remotely actuable braking apparatus 12. Here, by example and without limitation, the actuator module 20 includes the brake actuator 26, the electronic actuator drive module 28, and the battery pack or other power supply 30 housed as a single unit which is affixed to the bicycle's frame 18 by anchors 22, as illustrated in FIG. 1. According to one embodiment, the electronic actuator drive module 28 includes a radio frequency signal reception antenna 40 structured for receiving the radio frequency control signal 32 transmitted by the remote control module 14. The radio antenna 40 is coupled to a radio frequency signal receiver 42 tuned to receive the radio frequency control signal 32. The electronic actuator drive module 28 also includes a signal generator 44 coupled to the radio frequency signal receiver 42. The signal generator 44 is structured for generating an actuator drive signal in response to the radio frequency control signal 32 being received by the radio frequency signal receiver 42.

The brake actuator 26 is coupled to the signal generator 44 for receiving the actuator drive signal. The brake actuator 26 is further coupled to the auxiliary brake device 16 for operating the auxiliary brake device 16 in response to receiving the actuator drive signal.

The battery pack or other power supply 30 is coupled for powering both the actuator drive module 28 and the brake actuator 26.

According to one embodiment, the brake actuator 26 is a miniature linear actuator of a conventional type having a hydraulic or pneumatic cylinder capable of driving a piston rod 46 for activating the auxiliary brake device 16 for remotely stopping the bicycle 1. By example and without limitation, the brake actuator 26 is a miniature linear actuator is a 12 volt DC model 4ch-RC linear actuator commercially available from Firgelli Automations on the Web at www.firgelliauto.com. The miniature linear brake actuator 26 is capable of driving the piston rod 46 for engaging the auxiliary brake device 16 in a braking relationship with the wheel 2 or 3 (shown). By example and without limitation, the signal generator 44 is coupled to the miniature linear brake actuator 26 is optionally coupled to energize the brake actuator 26 in either a sustaining mode or a latching mode. When coupled to the signal generator 44 in the latching mode, the brake actuator 26 is fully actuated upon receiving the actuator drive signal and remains fully actuated until reset. Alternatively, when coupled to the signal generator 44 in the sustaining mode, the brake actuator 26 is actuated only while receiving the actuator drive signal, whereby the brake actuator 26 is optionally only partially actuated to engage the auxiliary brake device 16 for slowing the bicycle 1 without stopping it, or repeatedly actuated to pump the auxiliary brake device 16 for more gentle stopping of the bicycle 1.

When the brake actuator 26 is a 12 volt DC actuator, the battery pack or other power supply 30 is a 12 volt DC power supply.

While the brake actuator 26 is illustrated and described as a miniature linear actuator, other brake actuators are also contemplated and may be included or substituted without deviating from the scope and intent of the present invention.

According to one embodiment of the bicycle safety apparatus 10 the actuator cable 24 is embodied as a conventional bicycle brake cable having a substantially continuous stiff wire 48 slidable within a substantially continuous outer cable tube 50 which is coupled to the bicycle's frame 18 by one or more of the anchors 22.

When the brake actuator 26 is embodied as a miniature linear actuator, one end 52 of the stiff wire 48 portion of the actuator cable 24 is coupled to the piston rod 46 by a first connector 54 in a known manner, and an opposite end 56 of the stiff wire 48 is coupled to the brake device 16 by a second connector 58 in a known manner.

When the auxiliary brake device 16 is a conventional caliper brake, as shown, the auxiliary brake device 16 generally includes a pair of brake arms 60 and 62, a pair of brake shoes 64 and 66 carried on the brake arms 60, 62 respectively, a support 68 rotatably supporting the brake arms 60, 62, and a mounting means 70 (shown in FIG. 1) for mounting the caliper brake device 16 to the bicycle frame 18. One brake arm 60 of the pair is C-shaped and the other brake arm 62 is Y-shaped. An idle end of the C-shaped brake arm 60 of the pair is coupled by the second connector 58 to the terminal end 56 of the stiff wire 48 portion of the actuator cable 24, and one brake shoe 64 is attached thereto at the other end. The support 68 is positioned substantially intermediate of the C-shaped brake arm 60 in a known manner for rotatably supporting the brake arm 60. The Y-shaped brake arm 62 has three ends of which one carries the second connector 58 for the outer cable tube 50 covering the inner wire 48, and another end which carries the other brake shoe 66 corresponding to the brake shoe 64, and still another end which is provided with a bore through which the rotatable support 68 is inserted. The pair of the brake shoes 64, 66 are secured to the brake arms 60, 62 and positioned opposite to both lateral sides of a rim 72 of the front or rear bicycle wheel 2 or 3, respectively, so that the brake arms 60, 62 swing to urge the brake shoes 64, 66 to contact the lateral sides of the rim 72, respectively, to thereby brake the bicycle wheel 2 or 3. The auxiliary caliper brake device 16 of the braking apparatus 12 is thus adapted to pivotally support both the brake arms 60, 62 by means of the rotatable support 68.

Accordingly, when the auxiliary brake device 16 is a conventional caliper brake, as shown, the brake actuator 26 operates the auxiliary brake device 16 in response to receiving the actuator drive signal by pulling the first end 52 of the stiff wire 48 portion of the actuator cable 24, whereby the second end 56 of the stiff wire 48 pulls on the brake arms 60, 62 to compress the brake shoes 64, 66 against both lateral sides of the rim 72 of the front or rear bicycle wheel 2 or 3, respectively, and thereby stop the bicycle 1.

While the auxiliary brake device 16 is illustrated and described as a conventional caliper brake, other brake devices such as conventional coaster or drag brake devices are also contemplated and may be included or substituted without deviating from the scope and intent of the present invention.

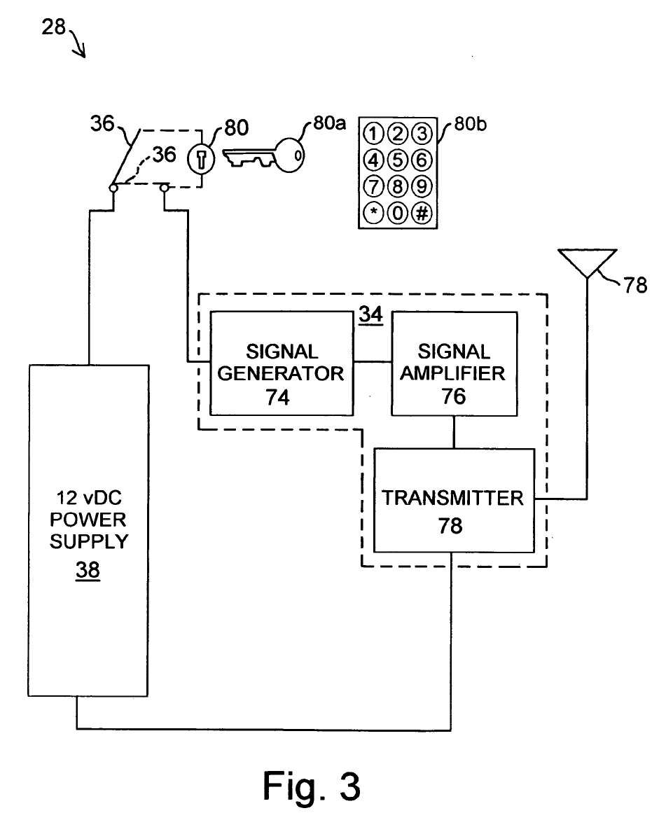

FIG. 3 is a block diagram that illustrates by example and without limitation the radio remote control module 14 for remotely controlling bicycle braking apparatus 12. As discussed herein, the electronic actuator drive module 28 is responsive to a radio frequency control signal 32 (shown in FIG. 1) transmitted by the remote control module 14. The remote control module 14 includes the electronic control signal activation module 34 having a radio frequency control signal generator 74 and capable of generating the radio frequency control signal 32 coupled to a signal amplifier 76 capable of amplifying the radio frequency control signal 32 generated thereby. The signal amplifier 76 is coupled to a radio frequency transmitter 78 capable of transmitting the amplified radio frequency control signal 32 via a radio frequency signal transmission antenna 79 capable of transmitting the amplified radio frequency control signal 32. The battery pack or other power supply 38 is coupled to power the electronic control signal activation module 34 for powering the radio frequency control signal generator 74, signal amplifier 76 and transmitter 78 in response to operation of the switch or other signal activator 36. According to one embodiment, upon activation of the control signal activation module 34, the radio frequency control signal generator 74 generates the radio frequency control signal 32 and passes it to the signal amplifier 76 which amplifies the control signal 32 appropriately and passes the amplified signal 32 to radio frequency transmitter 78 which transmits the radio frequency control signal 32 via the radio frequency transmission antenna 79.

According to one embodiment of the bicycle safety apparatus 10, the switch or other signal activator 36 is normally open such that the control signal activation module 34 normally de-energized and quiescent. Upon closing the signal activator 36 (shown in phantom), the control signal activation module 34 is coupled to the power supply 38 and thereby powered, whereupon the radio frequency control signal 32 is generated and transmitted by the transmission antenna 79 to the reception antenna 40 of the actuator drive module 28 for remotely activating the bicycle braking apparatus 12 to slow or stop the bicycle 1.

Alternatively, the switch or other signal activator 36 is normally closed (shown in phantom) such that the control signal activation module 34 normally powered and active. Accordingly, the control signal activation module 34 continuously generates and amplifies the control signal 32 which is continuously transmitted by the transmission antenna 79. The reception antenna 40 of the actuator drive module 28 portion of the bicycle braking apparatus 12 continuously receives the continuously transmitted control signal 32 and responsively activates the bicycle braking apparatus 12 to interlock the brake shoes 64, 66 of the auxiliary brake device 16 with the rim 72 of the front or rear bicycle wheel 2 or 3, respectively, and thereby hold the bicycle 1. Activation of the control module 14 moves the signal activator 36 from the normally closed state to the open state which removes power from the control signal activation module 34. Removal of power from the control signal activation module 34 breaks generation and transmission of the control signal 32, which in turn deactivates the bicycle braking apparatus 12 and permits the bicycle 1 to be ridden. This embodiment causes the normally closed signal activator 36 to operate as a failsafe or “dead man” switch, whereby the accidental or unavoidable loss of control of the signal activator 36 interrupts the control signal 32 and automatically engages the auxiliary brake device 16 for stopping the bicycle 1. Accordingly, the bicycle 1 cannot be ridden by a child except under the care of a parent or other supervisor capable of operating the control module 14. For increased security the control module 14 is optionally provided with a keyed lock 80 to resist moving the signal activator 36 into the normally closed position for normally energizing and activating the control signal activation module 34. For example, the keyed lock 80 is either a mechanical key mechanism operated by a mechanical key 80a, or a keypad 80b operated by entry of a key code.

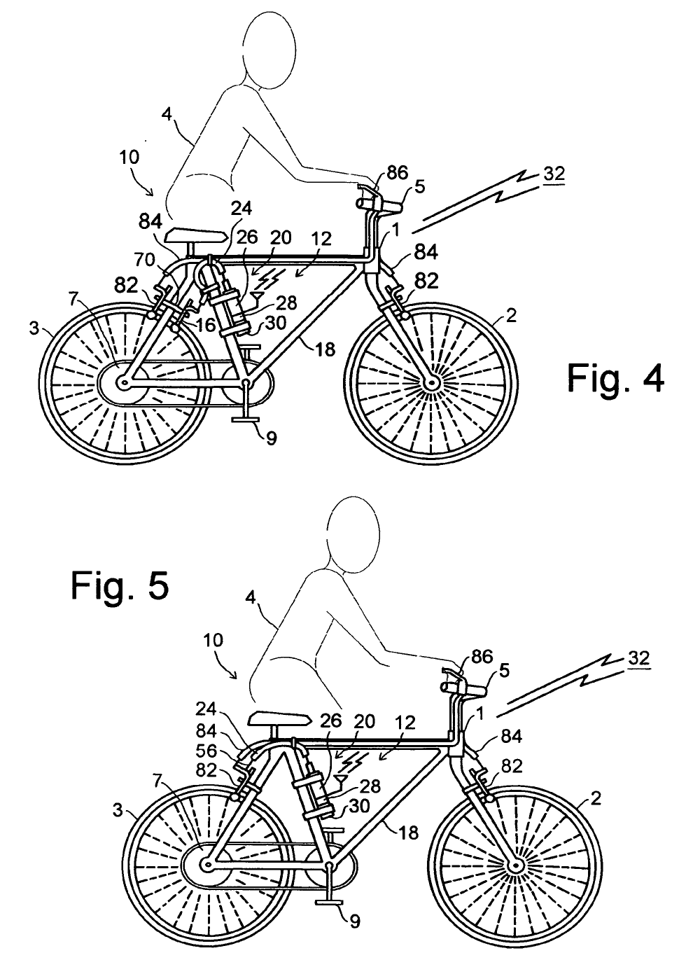

FIG. 4 illustrates one embodiment of the bicycle safety apparatus 10 being mounted on a bicycle 1 equipped with a set of original equipment (OEM) caliper brakes 82 coupled by cables 84 to handbrakes 86 mounted on the handlebars 5 for normal hand operation of the rider 4. The remotely actuable braking apparatus 12 is substantially as disclosed herein with the auxiliary brake device 16 being mounted for engaging either the front or rear bicycle wheel 2 or 3 (shown).

FIG. 5 illustrates another embodiment of the bicycle safety apparatus 10 being mounted on a bicycle 1 equipped with the set of caliper brakes 82 coupled by cables 84 to handbrakes 86 mounted on the handlebars 5 for normal hand operation of the rider 4. The remotely actuable braking apparatus 12 is substantially as disclosed herein except one of the OEM caliper brakes 82 is substituted for the auxiliary brake device 16. The brake actuator 26 of the actuator module 20 is operatively coupled to the OEM caliper brakes 82 through the actuator cable 24, whereby actuation of the brake actuator 26 as disclosed herein tensions the stiff wire 48 such that its second end 56 pulls on the arms to the OEM caliper brake 82 to slow or stop the bicycle 1.

Since both the auxiliary cable 24 and OEM cables 84 operate the respective auxiliary and OEM caliper brakes 16 and 82 by pulling the C-shaped brake arm 60, i.e., in tension, when the actuator module 20 operates the OEM caliper brakes 82, the OEM cable 84 to the rider's handbrake 86 goes slack so that it does not interfere with operation of the bicycle safety apparatus 10. On the other hand, when the rider's handbrake 86 is used to operate the OEM caliper brakes 82, the stiff wire 48 portion of the actuator cable 24 slackens so the bicycle safety apparatus 10 does not interfere with the rider's normal operation of the OEM caliper brakes 82.

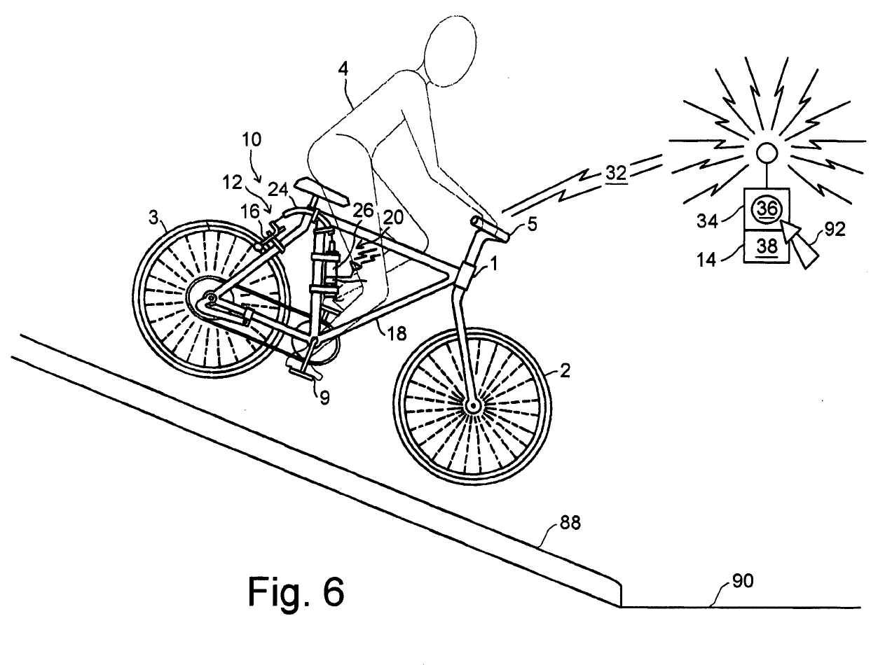

FIG. 6 illustrates a method of operation of the novel bicycle safety apparatus 10 when a child or other rider 4 is observed operating the bicycle 1 unsafely such as the rider 4 guiding the bicycle 1 down a hill or other slope 88 toward a cross street or other potentially hazardous area 90, or otherwise being at risk of entering such potentially hazardous area 90. With the remotely actuable braking apparatus 12 of the bicycle safety apparatus 10 installed on the bicycle 1 and the parent or other supervisor having the control module 14 in hand, the supervisor observes or otherwise detects the bicycle 1 and rider 4 approaching the potentially hazardous area 90. As indicated by arrow 92 the supervisor or other system operator pushes or otherwise operates the switch or other signal activator 36 of the handheld control module 14. When the bicycle safety apparatus 10 is embodied having the switch or other signal activator 36 configured as normally open with the control signal activation module 34 normally de-energized and quiescent, the operation of the switch or other signal activator 36 couples the control signal activation module 34 to the power supply 38 whereby the control signal activation module 34 is powered. Powering of the control signal activation module 34 causes the signal generator 74 to generate the radio frequency control signal 32. The control signal 32 is passed to the signal amplifier 76 which amplifies the control signal 32 and passes it to the transmitter 78 for transmission via antenna 79 which transmits the radio frequency control signal 32 for remotely activating the bicycle braking apparatus 12. The signal receiver 42 of the actuator drive module 28 of the bicycle braking apparatus 12 receives the radio frequency control signal 32 via the reception antenna 40 and passes the received control signal 32 to the signal generator 44. The signal generator 44 generates the actuator drive signal in response to receiving the radio frequency control signal 32.

The brake actuator 26 receives the actuator drive signal from the signal generator 44 and responsively drives the piston rod 46 for activating the auxiliary brake device 16 for remotely stopping the bicycle 1. As disclosed herein, the piston rod 46 responsively pulls the first end 52 of the stiff wire 48 portion of the actuator cable 24, whereby the stiff wire 48 slides in the outer cable tube 50 such that the second wire end 56 pulls on the brake arms 60, 62 to compress the brake shoes 64, 66 against both lateral sides of wheel rim 72 of either the front or rear bicycle wheel 2 or 3 and thereby slow or even stop the bicycle 1 and rider 4.

When the brake actuator 26 is coupled to the signal generator 44 in the latching mode, the brake actuator 26 is fully actuated upon receiving the actuator drive signal from the signal generator 44 and remains fully actuated until reset. Alternatively, when the brake actuator 26 is coupled to the signal generator 44 in the sustaining mode, the brake actuator 26 is actuated only while receiving the actuator drive signal from the signal generator 44, whereby the brake actuator 26 is optionally only partially actuated to engage the auxiliary brake device 16 for slowing the bicycle 1 without stopping it, or repeatedly actuated to pump the auxiliary brake device 16 for more gentle stopping of the bicycle 1.

Alternatively, when the bicycle safety apparatus 10 is embodied having the switch or other signal activator 36 configured as normally closed (shown in phantom in FIG. 3) such that the control signal activation module 34 normally powered and active, the control signal activation module 34 continuously generates and amplifies the control signal 32 which is continuously transmitted by the transmission antenna 79. The reception antenna 40 of the actuator drive module 28 portion of the bicycle braking apparatus 12 continuously receives the continuously transmitted control signal 32 and responsively activates the brake actuator 26 to interlock the brake shoes 64, 66 of the auxiliary brake device 16 with the rim 72 of the front or rear bicycle wheel 2 or 3 (shown) and thereby holds the bicycle 1 stationary. As indicated by arrow 92 the supervisor or other system operator pushes or otherwise operates the switch or other signal activator 36 of the handheld control module 14 if the rider 4 is operating the bicycle 1 in a safe manner away from the potentially hazardous area 90. When the normally closed signal activator 36 is protected by the optional keyed lock 80, the operator operates the keyed lock 80 using, for example, either the physical key 81a or the key code entered via the keypad 81b. Opening the normally closed signal activator 36 interrupts energy from the power supply 38 and de-energizes the control signal activation module 34. This de-energizing of the control signal activation module 34 interrupts generation and transmission of the control signal 32, which in turn deactivates the bicycle braking apparatus 12 and permits the bicycle 1 to be moved.

However, if the rider 4 begins operating the bicycle 1 in an unsafe manner or unsafely approaches the potentially hazardous area 90, the system operator simply releases or otherwise operates the signal activator 36 of the handheld control module 14. The circuit is completed and energy again flows to the control signal activation module 34 which responsively generates and amplifies the control signal 32 which is transmitted by the transmission antenna 79. The bicycle braking apparatus 12 receives the control signal 32 transmitted by the handheld control module 14 and responsively activates the brake actuator 26 to activate the auxiliary brake device 16 for slowing or stopping the bicycle 1 and rider 4.

When conditions are safe for the bicycle 1 and rider 4 the supervisor or other system operator again operates the signal activator 36 of the handheld control module 14 to transmit the control signal 32 and deactivate the bicycle braking apparatus 12 so the rider 4 can resume operating the bicycle 1.

Although described herein for application to a bicycle, the bicycle safety apparatus 10 is optionally applied to any wheeled vehicle normally propelled by motive force of the rider applied to one or more pedals coupled to the wheel or wheels, including but not limited to unicycles, tricycles, toy cars and wagons. The bicycle safety apparatus 10 is also optionally applied to other wheeled vehicles propelled by motive force of the rider, including but not limited to wheel chairs.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1. A safety apparatus for a rider motivated wheeled vehicle, comprising:
a remote control module, comprising:
an electronic control signal activation module,
a manual signal activator coupled for activating the electronic control signal activation module for generating a control signal, and
a power supply coupled for powering the electronic control signal activation module; and
a remotely actuable braking apparatus, comprising:
an auxiliary brake device positionable for engaging at least one wheel of a rider motivated wheeled vehicle;
an electrically powered actuator module coupled to the auxiliary brake device, the actuator module being responsive to a received control signal for operating the auxiliary brake device, and
a power supply coupled for powering the actuator module.

2. The apparatus of claim 1 wherein the control signal further comprises a radio frequency control signal;
the control signal activation module of the remote control module further comprises a radio frequency transmitter coupled for transmitting the radio frequency control signal; and
the actuator module of the remotely actuable braking apparatus further comprises a radio frequency receiver coupled for receiving the transmitted radio frequency control signal.

3. The apparatus of claim 2 wherein the control signal activation module further comprises a control signal generator coupled to the transmitter for generating the control signal transmitted thereby.

4. The apparatus of claim 3 wherein the manual signal activator is a normally open switch and is further closable for the activating the electronic control signal activation module for generating the control signal.

5. The apparatus of claim 4 wherein the electrically powered actuator module further comprises an actuator coupled for driving the auxiliary brake device for engaging the wheel.

6. The apparatus of claim 5 wherein the wheeled vehicle further comprises a bicycle.

7. The apparatus of claim 6 wherein the auxiliary brake device further comprises a caliper brake.

8. The apparatus of claim 7 wherein the actuator further comprises a linear actuator comprising a piston rod coupled to operate the auxiliary brake device.

9. A safety apparatus for a rider motivated wheeled vehicle, comprising:
a) a remote control module, comprising:
i) an electronic control signal activation module, comprising a control signal generator and a control signal transmitter,
ii) a power supply coupled for powering the electronic control signal activation module, and
iii) a manual switch coupled for coupling the power supply to the electronic control signal activation module for generating and wirelessly transmitting the control signal; and
b) a remotely actuable braking apparatus, comprising:
i) an auxiliary brake device attachable to a frame of a bicycle in operable proximity to a wheel thereof, and
ii) an actuator module coupled for operating the auxiliary brake device, the actuator module further comprising:
1) an actuator drive module responsive to the wirelessly transmitted control signal for generating an actuator drive signal,
2) an actuator coupled to the actuator drive module for receiving the actuator drive signal generated thereby and further coupled for operating the auxiliary brake device responsively to receiving the received actuator drive signal, and
3) a power supply coupled for powering the actuator drive module and actuator.

10. The apparatus of claim 9 wherein the electronic control signal activation module further comprises a signal amplifier coupled for amplifying the generated control signal, and an antenna coupled for transmitting the amplified control signal.

11. The apparatus of claim 10 wherein the actuator drive module further comprises:
an antenna,
a receiver coupled to the antenna for receiving the control signal, and
an actuator drive signal generator coupled to the receiver for responsively generating the actuator drive signal.

12. The apparatus of claim 11 wherein the actuator further comprises a linear actuator comprising a piston rod coupled to operate the auxiliary brake device for engaging the bicycle wheel in operable proximity thereto.

13. The apparatus of claim 12 wherein the remotely actuable braking apparatus further comprises an actuator cable coupled between the linear actuator and an operative portion of the auxiliary brake device.

14. A safety apparatus for a rider motivated wheeled vehicle, comprising:
a) a remote control module, comprising:
i) an electronic control signal activation module, the control signal activation module being battery operated and further comprising:
1) a radio frequency control signal generator,
2) a signal amplifier coupled to the radio frequency control signal generator for amplifying a radio frequency control signal generated thereby, and
3) a radio frequency signal transmitter coupled to the signal amplifier for transmitting the amplified radio frequency control signal, and
4) a radio frequency signal transmission antenna coupled to the radio frequency signal transmitter for transmitting the amplified radio frequency control signal;
ii) a twelve volt power supply coupled for powering the electronic control signal activation module, and
iii) a manual switch coupled for energizing the electronic control signal activation module for generating the radio frequency control signal; and
b) a remotely actuable braking apparatus, comprising:
i) an auxiliary brake device attachable to a frame of a bicycle in operable proximity to a rear wheel thereof, and
ii) an electronic actuator module coupled for operating the auxiliary brake device, the actuator module being battery operated and further being responsive to a received radio frequency control signal for operating the auxiliary brake device, the actuator module further comprising:
1) an actuator drive module comprising:
I) a radio frequency signal reception antenna,
II) a radio frequency signal receiver coupled to the reception antenna and tuned for receiving the radio frequency control signal, and
III) an actuator drive signal generator coupled to the radio frequency signal receiver for receiving the radio frequency control signal received thereby and responsively generating an actuator drive signal,
2) an actuator coupled to the actuator drive signal generator for receiving an actuator drive signal generated thereby and further coupled for operating the auxiliary brake device responsively to receiving the actuator drive signal, and
3) a twelve volt power supply coupled for powering the actuator drive module and actuator.

15. A safety method for a rider motivated wheeled vehicle, comprising:
a) on a wheeled vehicle normally propelled by motive force of the rider, mounting a remotely actuable braking apparatus, the mounting of the braking apparatus further comprising:
i) attaching a brake device to a frame of a bicycle in operable proximity to a wheel thereof,
ii) attaching an actuator module to the bicycle frame in operable coupling with the brake device,
b) an observer observing the wheeled vehicle being operated unsafely for a rider;
c) the observer responsively operating a handheld electronic radio frequency remote control module for remotely controlling the remotely actuable braking apparatus, the operating the remote control module further comprising actuating a radio frequency control signal for engaging the brake device with the wheel of the wheeled vehicle;
d) the actuator module of the remotely actuable braking apparatus receiving the radio frequency control signal and responsively engaging the brake device with the wheel of the wheeled vehicle.

16. The method of claim 15, further comprising the observer again operating the handheld electronic radio frequency remote control module, the again operating the remote control module further comprising actuating a radio frequency control signal for disengaging the brake device from engagement with the wheel of the wheeled vehicle.

17. The method of claim 16 wherein the observer actuating a radio frequency control signal for engaging the brake device with the wheel of the wheeled vehicle further comprises either energizing an electronic control signal activation module for generating and transmitting the radio frequency control signal, or de-energizing the electronic control signal activation module for interrupting a substantially continuous generating and transmitting of the radio frequency control signal.

18. The method of claim 17 wherein the observer actuating a radio frequency control signal for engaging the brake device with the wheel of the wheeled vehicle further comprises only energizing an electronic control signal activation module for generating and transmitting the radio frequency control signal; and
wherein the energizing an electronic control signal activation module for generating and transmitting the radio frequency control signal further comprises:
closing a switch for coupling a power supply to the electronic control signal activation module; and
the coupling the power supply to the electronic control signal activation module initiating operating of a radio frequency control signal generator for generating a radio frequency control signal, amplifying the generated radio frequency control signal, and transmitting the amplified radio frequency control signal.

19. The method of claim 18 wherein the actuator module of the remotely actuable braking apparatus receiving the radio frequency control signal and responsively engaging the brake device with the wheel of the wheeled vehicle further comprises:
receiving the radio frequency control signal by a radio frequency signal reception antenna;
tuning a radio frequency signal receiver for receiving the radio frequency control signal;
the tuned radio frequency signal receiver receiving the radio frequency control signal;
the tuned radio frequency signal receiver passing the received radio frequency control signal to an actuator drive signal generator coupled to the radio frequency signal receiver;
the actuator drive signal generator generating an actuator drive signal responsively to receiving the radio frequency control signal;
the actuator drive signal generator passing the actuator drive signal to an actuator coupled to the actuator drive signal generator for receiving the actuator drive signal generated thereby; and
responsively to receiving the actuator drive signal, the actuator operating the brake device for engaging the brake device with the wheel of the wheeled vehicle.

20. The method of claim 17 wherein the observer actuating a radio frequency control signal for engaging the brake device with the wheel of the wheeled vehicle further comprises initially operating the energizing the electronic control signal activation module for generating and transmitting the radio frequency control signal, the initially operating the energizing the electronic control signal activation module further comprising coupling a power supply to the electronic control signal activation module initiating operating of a radio frequency control signal generator for substantially continuously generating the radio frequency control signal, amplifying the generated radio frequency control signal, and transmitting the amplified radio frequency control signal;
wherein the actuator module of the remotely actuable braking apparatus receiving the radio frequency control signal further comprises engaging the brake device with the wheel of the wheeled vehicle responsively to receiving the radio frequency control signal;
wherein the observer actuating a radio frequency control signal for engaging the brake device with the wheel of the wheeled vehicle further comprises interrupting the substantially continuously generating and transmitting of the radio frequency control signal, the interrupting the generating and transmitting of the radio frequency control signal further comprising:
actuating a switch for decoupling a power supply from at least a transmitting portion of the electronic control signal activation module for de-energizing at least the transmitting portion of the electronic control signal activation module, and
the de-energizing at least the transmitting portion of the electronic control signal activation module initiating at least momentary ceasing of at least the substantially continuously transmitting the radio frequency control signal.
